(19) United States
(12) Patent Application Publication
(10) Pub. No.: US 2008/0046256 A1
(43) Pub. Date: Feb. 21, 2008

(54) Casino Promoting Device System and Method

(76) Inventor: Avraham KALDERON, Tel Aviv (IL)

Correspondence Address: BRUCE E. LILLING;LILLING & LILLING PLLC, P.O. BOX 560, GOLDEN BRIDGE, NY, 10526, US

(21) Appl. No.: 11/462,448

(22) Filed: Aug. 4, 2006

(51) Int. Cl. G06Q 10/00; G06Q 30/00; H04L 9/00; H04K 1/00

(52) U.S. Cl. 705/1; 705/80

(57) ABSTRACT

A networked software junketeer for mediating between at least a first agent and at least a first casino operator comprising: a website comprising an agent side in data communication with a casino side; the agent side for offering at least a conditional deal to a punter of the agent in accordance with a punter profile; the casino side for allowing participating casino operators to post details of conditional deals for display on agent side; the agent side being able to accept a conditional deal, provide written details of obligations to the punter and to bill the punter a nominal price for the deal to and notify the participating casino operator by reporting the casino side with details of the punter and the deal; the casino side for confirming conditional deal, receiving details of punter and a facility for paying a commission to the agent, thereby providing an incentive to the agent to broker the deal, wherein the obligations include a gaming related obligation.

### BACKGROUND OF THE INVENTION

1. Field of the Invention

The present invention is directed to providing a method and system for enabling travel agents to alert casinos regarding potential clients who are vacating in their proximity and collecting financial compensation for the service provided.

2. Summary of the Prior Art

Gambling is a widespread leisure phenomenon. The possibility of winning provides an adrenalin rush that provides enjoyment to many. However gambling can be addictive. Consequently, legislators in many countries see gambling as a social ill with some people losing more money than they can afford.

In consequence, casinos are illegal in some countries, and are restricted to remote zones in others. To attract the gamblers, a host of other leisure activities develop around casinos in holiday cities such as Las Vegas, including shows and restaurants.

Different casinos resorts, such as Monte Carlo, Las Vegas, etc. compete with each other for the serious, wealthy gamblers. Additionally, different casinos within the same resort compete with each other.

Flights, hotel rooms, theatre tickets, restaurant meals and a host of other conventional services have fixed prices and middlemen such as travel agents can collect a percentage. Travel agents earn their living by selling such services. The only obligation on the purchaser is to pay for the service sold. Negotiating deals is straightforward, as the service provider knows the value of the service and can offer the travel agent a fixed or proportionate commission. The travel agent can sell the service, providing a receipt and deduct the agreed on commission before passing on the money corrected.

Although the punters win or lose at precalculated odds, a well run casino takes a constant percentage of the action. Thus for roulette for example, the bets placed on black, red, odds, evens, 1-18 and 19-36 enable the punter to double his money. The casino operator offers odds of 2:1 but the mathematical odds are 37:18 against.

The difference between the mathematical odds of winning and the odds offered the punters is the source of income of the casino. There are fixed costs in running a casino of course, including security, croupiers and the like. Generally the profitability of the casino is a function of the action, which depends on the number of punters, the size of the bets and the length of time each punter spends at the tables.

Casino operators pander their clientele and will provide free meals, theatre tickets and hotel rooms to high quality punters. These punters are usually identified once they are at the casino, and the courtesy service is to keep the punters happy, to extend their visit, and to some extent to encourage them to return. Treating punters well once they arrive does little to attract punters in the first place.

Casinos are willing to pay large sums of money to attract clientele, and there is a sub-industry of group organizers and guides, otherwise known as junketeers, that collect commissions for bringing in the punters.

Junketeering is more complicated than selling airplane flights or tickets for shows. The correct compensation for the service provided by the junketeer to a casino depends on the amount of play that the punter makes. This is generally a function of time spent at the gaming tables and the size of the bets placed. It is important to realize that casinos themselves don't really gamble.

Junketeers typically close their deals with casinos from overseas. The casinos have to accept the junketeer's word regarding the gambling habits of the punter, and/or the junketeer has to accept the casino operator's word that he will get paid for directing each punter to the casino.

Negotiating between junketeer and casino is typically labor intensive on both sides, with direct phone calls followed by signed faxes being the norm.

The present invention addresses the issue of bringing punters to casinos and describes a device and method of usage and an associated method of doing business.

### SUMMARY OF THE INVENTION

It is an aim of the invention to promote casinos.

In a first aspect, the present invention is directed to providing a networked software junketeer for mediating between at least a first agent and at least a first casino operator comprising: a website comprising an agent side in data communication with a casino side; the agent side for offering at least a conditional deal to a punter of the agent in accordance with a punter profile; the casino side for allowing participating casino operators to post details of conditional deals for display on agent side; the agent side being able to accept a conditional deal, provide written details of obligations to the punter and to bill the punter a nominal price for the deal to and notify the participating casino operator by reporting the casino side with details of the punter and the deal; the casino side for confirming conditional deal, receiving details of punter and a facility for paying a commission to the agent, thereby providing an incentive to the agent to broker the deal, wherein the obligations include a gaming related obligation.

Typically the conditional deal includes provision of services selected from the list of entertainment, travel to and from airport, accommodation and food.

Typically the commission is selected from a fixed amount and a percentage of a nominal price of the deal.

Typically the reporting comprises details selected from the list of name, income bracket and image of the punter.

Optionally and preferably, the reporting comprises further details regarding the punter including likes and dislikes.

By way of example, the gaming related obligation of the punter may comprise at least one of the list of playing a pre-selected time period in the casino and depositing a pre-agreed deposit with the casino.

Typically the agent is selected from the list of travel agents, hosts and junketeers.

Alternatively, the agent is the punter and the commission is a discount for directly purchasing the conditional deal.

In a second aspect, the present invention is directed to providing a method of promoting a casino comprising offering commissions to agents on nominal price of conditional deals provided to punters by the casino over a networked computer interface, the gaming related obligation of the punter comprises at least one of the list of playing a pre-selected time period in the casino and depositing a pre-agreed deposit with the casino.

Typically, at least one of the following limitations applies to the method:

the conditional deal comprises services selected from the list of entertainment, travel to and from airport, accommodation and food;

the commission is either calculated as a percentage of the nominal price of a conditional deal sold or is a fixed sum per conditional deal;

the commission is payable to the agent on completion of the gaming obligations by punter as detailed in the conditional deal, or is paid for by punter to agent when booking the deal and the commission is retained by the agent only if terms of deal are fulfilled;

the agent is selected from the list of a travel agent, a host or a junketeer or is the punter himself directly purchasing the deal, and the commission is a discount for directly purchasing the conditional deal;

the casino operator provides the punter with proof of fulfillment of the gaming obligation and punter uses said proof of fulfillment to obtain a refund from the agent, and

proof of fulfillment of gaming obligation is used by agent to collect the commission.

In a third aspect, the present invention is directed to providing a networked software implementation for enabling agents to promote casinos by providing conditional details of punters in return for a commission wherein the commission is payable if the punter fulfils a gaming obligation.

Typically the networked software implementation further comprises at least one of the following limitations:

the conditional deal comprises services selected from the list of entertainment, travel to and from airport, accommodation and food;

the commission is either calculated as a percentage of the nominal price of a conditional deal sold or is a fixed sum per conditional deal;

the commission is payable to the agent on completion of the gaming obligations by punter as detailed in the conditional deal, or is paid for by punter to agent when booking the deal and the commission is retained by the agent only if terms of deal are fulfilled;

the agent is selected from the list of a travel agent, a host or a junketeer or is the punter himself directly purchasing the deal, and the commission is a discount for directly purchasing the conditional deal;

the casino operator provides the punter with proof of fulfillment of the gaming obligation and punter uses said proof of fulfillment to obtain a refund from the agent, and

proof of fulfillment of gaming obligation is used by agent to collect the commission.

### BRIEF DESCRIPTION OF THE FIGURES

For a better understanding of the invention and to show how it may be carried into effect, reference will now be made, purely by way of example, to the accompanying drawing.

With specific reference now to the drawing in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

In the accompanying drawings:

FIG. 1 is a schematic illustration of a networked software junketeer of the present invention, and

FIG. 2 is the steps of a method for promoting casinos.

### DETAITLED DESCRIPTION OF THE PREFERRED EMBODIMENTS

The present invention relates to bringing punters to casinos. It has been noted that travel agents, particularly of the rich, frequent travelers, develop a personal relationship with the traveler and get to know the travelers likes, dislikes and taste. The travel agent can be very helpful in booking hotels and suggesting other services.

To the knowledge of the applicant, who has several years experience in the gambling industry, the travel agent's unique insight into the travel arrangements and interests of his clients, has never been utilized to help promote specific casinos.

Travel agents are computer literate. Indeed, much of their work involves finding flights, tickets, car hire deals, hotels and the like over the internet.

The present invention proposes an Interent based service wherein the travel agent can alert casino owners of travel arrangements of prospective punters, provide details of the punter's likes and dislikes, and help the punter enjoy his holiday. The casino will provide a commission to the travel agent for the service. Such a commission may be a fixed sum, but will typically be a variable commission that is based on the type of flight ticket booked by the client or the room-charge of the hotel where the punter stays. It may be a percentage of the money spent by the punter in the casino.

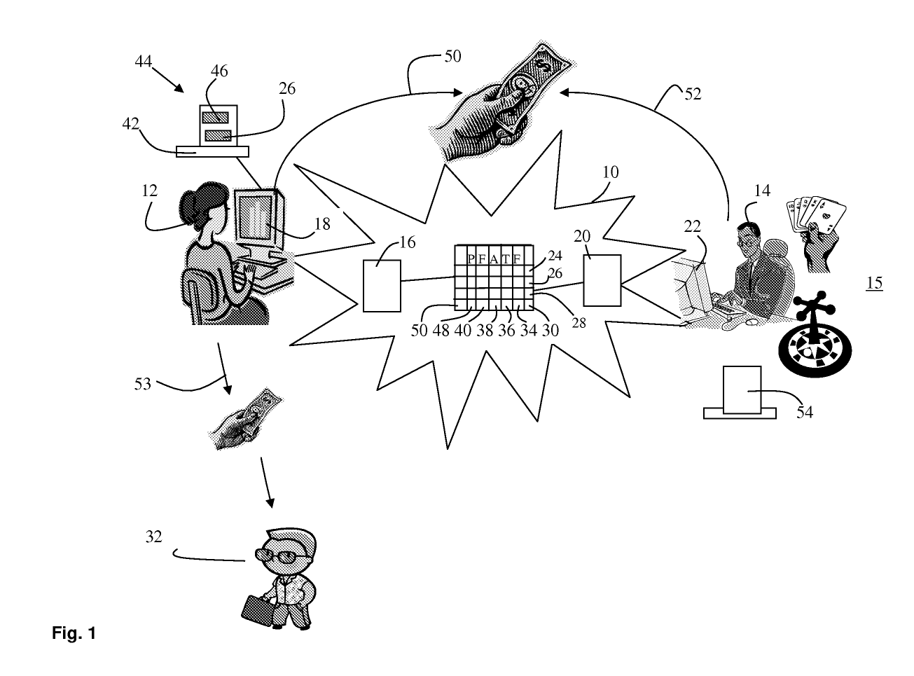

Referring to FIG. 1, a networked software junketeer 10 for mediating between at least a first agent 12 and at least a first casino operator 14 is shown. The networked software junketeer 10 is essentially a website having an agent side 16 displayable to a travel agent 12 on a networked computer terminal 18, in data communication with a casino side 20 displayable to casino operators 14 on their networked terminals 22.

Participating casino operators 14 devise deals 24, 26, 28, 30 designed to attract punters 32. The deals will typically be in different classes for different types of punter 32 and include at least some of the following elements: (i) entertainment 34, travel 36, (iii) accommodation 38 and (iv) food 40.

Entertainment 34 will typically include tickets for shows, films and the like, with the number of entertainments provided, the position in the audience, i.e. stalls, gallery, box, etc., whether a matinee or evening show is provided, being variable on the length of stay, commitment to play for certain time period in the casino 15, or deposit at the casino 15. Travel 36 will typically be between the casino 15 and the airport. The travel arrangements offered will depend on the quality of the punter. The travel 36 may be by limousine for high quality punters, or by coach or minibus for less affluent or less heavy gamblers. Accommodation 38 will usually be in the hotel associated with the casino 15 if there is one, or in one of the nearby hotels. The standard of room will typically be variable with the deal. Similarly (iv) food 40 may be vouchers for hotel dining room or local restaurants, or a la carte dining; the budget being dependent on the specific deal. It is stressed that the casino side 22 devises its own deals and prices. These may vary throughout the year reflecting the state of business. The casino side 22 allows the participating casino operator 14 to post details of conditional deals, which are then accessible by the agent side 16 and displayable on the agent terminal 18.

The agent side 16 allows the agent 12 to view the deal on his terminal 18 and to offer any available conditional deal 24, 26, 28, 30 to the prospective punter 32 who is a customer of the agent 12. The appropriate deal will depend on the punter's profile. Typically certain deals will be open only to frequent flyers, to men traveling alone, to families, etc.

The agent side 20 is able to accept a conditional deal 26 offered and to download to a printer 42 and to print out a written contract 44 listing obligations 46 of the punter and the deal 26 offered by the casino operator 14. The obligations 46 will typically include spending a certain period of time gambling in the casino 15 and/or depositing a certain sized deposit with the casino 15. Essentially the obligations 46 and deal 26 typically resemble those offered by junketeers and/or by hosts at the casino 15 in prior art promotion techniques.

The agent 12 may bill the punter 32 a nominal price 48 for the deal 26 agreed, and then notify the participating casino operator 14 by reporting the casino side 22 with details of the punter 32 and the deal 26. The casino side 20 will typically confirm the conditional deal 26, receiving details of punter 32. The networked software junketeer 10 has an associated mechanism 50 for transferring money between agent 12 and casino operator 14, and for paying a commission 52 to the agent 12, thereby providing an incentive to the agent 12 to broker the deal 26.

The commission 52 may be a fixed amount, but will typically be a percentage of a nominal price 48 of the deal 26. If the punter 32 does not fulfill the obligations 46 of the deal 26, optionally a lower quality deal may be set up or a lesser commission paid. Similarly, in some embodiments, payment of a higher commission may be paid, such as if the host at the casino 15 decides to pamper the punter with additional benefits. Thus the commission 52 may be a sliding amount varying say, between 0% and 30% of the nominal price 48 of the deal 26.

The agent 12 reports details of the deal 26 offered to and accepted by the punter 32. The reporting will typically be by an e-mail or by filling in boxes in the agent interface of the agent side 16. The reporting will include details for identifying the punter 32, such as his name. Usefully, an image of the punter will also be reported. This is useful for picking up the punter 32 at the airport, and may be additionally valuable in that hosts at the casino 15 can recognize and greet punters by name. Personal attention of this type can certainly add to the casino 15 experience, serving the interests of both casino operator 14 and punter 32. Other details, such as the punter's likes, dislikes, dietary requirements etc. may be transmitted. Typically the information will be willingly provided by the punter 32 as it makes his stay more enjoyable. Certainly no information that contravenes privacy legislation will be provided.

To qualify for a deal, the punter 32 will typically undertake obligations 46 regarding the gambling. Such obligations 46 on the punter 32 may include an undertaking to play a pre-selected time period in the casino 15 or to deposit a pre-agreed sum with the casino 15 to cover bets.

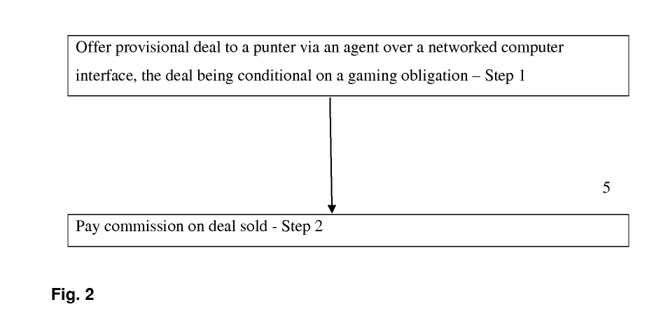

With reference to FIG. 2, a method of promoting a casino 15 is disclosed. The method consists of offering deals 24, 26, 28, 30 (Step 1) to punters 32 via travel agents 12 over a networked computer interface 20 and paying commissions 52 (Step 2) to the travel agents 12 on the nominal price 48 of the deal accepted 26.

By way of example, the deal 26 typically includes a package of services such as entertainment 34, travel to and from airport 36, accommodation 38, either in a hotel associated with the casino, or in a hostelry in the vicinity, and food 40. Specific deals need not include any or all of these elements. The commission 52 may be a fixed sum per deal 26, but will typically be calculated as a percentage of the nominal price 48 of a deal 26 sold.

In preferred embodiments the commission 52 is payable to the agent 12 only on completion of the obligations 46 accepted on himself by the punter 32 as detailed in the deal 26. For example, after the trip, if the punter 32 has spent the required time at the gambling tables or has left a suitable deposit with the casino 15 throughout the trip, he may apply to the agent 12 for a refund 53, providing proof 54 supplied by the casino operator 14. The proof 54 provides the agent 12 with evidence that the punter 32 has fulfilled his obligations 46 and the proof 54 enables the agent 12 to collect his commission 52. The nominal price 48 of the deal 26 is paid for by punter 32 to the agent 12 and the commission 52 is retained by the agent 12 only if the terms of the deal 26 are fulfilled.

Typically the casino operator 14 provides the punter 32 with proof of fulfillment of the terms of the deal 26 and the punter 32 uses the proof 54 of fulfillment of his obligations 46 to obtain a refund 53 from the agent 12 The proof 54 of fulfillment of the obligations 46 of the deal 26 are then used by the agent 12 to collect his commission 52.

Both the proof 54 and commission 52 may be supplied and paid electronically. Indeed the commission 52 may simply be debited from the payment provided by the punter 32 to the agent 12 before being paid to the casino operator 14 and the casino operator 14 may refund the payment directly.

Until now, travel agents 12 have been unable to benefit from the main business of casino holidays, such as trips to Las Vegas or Monte Carlo, merely selling and taking commissions for the peripheral services such as flight tickets and accommodation.

Travel agents 12 are the only people who really know where and when quality punters 32 travel to casino resorts.

Thus a networked software junketeer 10 for enabling travel agents 12 to promote casinos 15 by providing details of punters 32 in return for a commission 52 and a method for promoting casinos 15 are described. Unlike regular services provided by travel agents 12, such as hotel bookings and airplane tickets which are payable when sold, in the present invention the commission 52 is paid by the casino 15 only after the obligations of the deal 26 are met and the nominal cost 48 of the deal 26 is refunded to the punter 32 after the terms are met. Thus the punter 32, the casino operator 14 and the travel agent 12 all benefit.

Thus persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A networked software junketeer for mediating between at least a first agent and at least a first casino operator comprising:
a website comprising an agent side in data communication with a casino side; the agent side for offering at least a conditional deal to a punter of the agent in accordance with a punter profile;
the casino side for allowing participating casino operators to post details of conditional deals for display on agent side;
the agent side being able to accept a conditional deal, provide written details of obligations to the punter and to bill the punter a nominal price for the deal to and notify the participating casino operator by reporting the casino side with details of the punter and the deal;
the casino side for confirming conditional deal, receiving details of punter and a facility for paying a commission to the agent, thereby providing an incentive to the agent to broker the deal, wherein the obligations include a gaming related obligation.

2. The networked software junketeer of claim 1 wherein the conditional deal includes provision of services selected from the list of entertainment, travel to and from airport, accommodation and food.

3. The networked software junketeer of claim 1 wherein the commission is selected from a fixed amount and a percentage of a nominal price of the deal.

4. The networked software junketeer of claim 1 wherein the reporting comprises details selected from the list of name, income bracket and image of the punter.

5. The networked software junketeer of claim 4 wherein the reporting comprises further details regarding the punter including likes and dislikes.

6. The networked software junketeer of claim 1 wherein the gaming related obligation of the punter comprises at least one of the list of playing a pre-selected time period in the casino and depositing a pre-agreed deposit with the casino.

7. The networked software junketeer of claim 1 wherein the agent is selected from the list of travel agents, hosts and junketeers.

8. The networked software junketeer of claim 1 wherein the agent is the punter and the commission is a discount for directly purchasing the conditional deal.

9. A method of promoting a casino comprising offering commissions to agents on nominal price of conditional deals provided to punters by the casino over a networked computer interface, wherein the conditional deal requires a gaming obligation on the punter.

10. The method of claim 9 wherein the gaming related obligation of the punter comprises at least one of the list of playing a pre-selected time period in the casino and depositing a pre-agreed deposit with the casino.

11. The method of claim 9 wherein the conditional deal comprises services selected from the list of entertainment, travel to and from airport, accommodation and food.

12. The method of claim 9 wherein the commission is calculated as a percentage of the nominal price of a conditional deal sold.

13. The method of claim 9 wherein the commission is a fixed sum per conditional deal.

14. The method of claim 9 wherein the commission is payable to agent on completion of gaming obligations by punter as detailed in the conditional deal.

15. The method of claim 9 wherein the nominal price of deal is paid for by punter to agent and commission is retained by agent if terms of deal are fulfilled.

16. The method of claim 9 wherein the agent is the punter and the commission is a discount for directly purchasing the conditional deal.

17. The method of claim 9 wherein the casino operator provides punter with proof of fulfillment of terms of deal including gaming obligations and punter uses said proof of fulfillment to obtain a refund from the agent.

18. The method of claim 17 wherein the proof of fulfillment used to obtain refund is used by agent to collect commission.

19. A networked software implementation for enabling agents to promote casinos by providing conditional details of punters in return for a commission wherein the commission is payable if the punter fulfills a gaming obligation.

20. The networked software implementation of claim 19 further comprising at least one of the following limitations:
(a) the gaming related obligation of the punter comprises at least one of the list of playing a pre-selected time period in the casino and depositing a pre-agreed deposit with the casino;
(b) the conditional deal comprises services selected from the list of entertainment, travel to and from airport, accommodation and food;
(c) the commission is either calculated as a percentage of the nominal price of a conditional deal sold or is a fixed sum per conditional deal;
(d) the commission is payable to the agent on completion of the gaming obligations by punter as detailed in the conditional deal, or is paid for by punter to agent when booking the deal and the commission is retained by the agent only if terms of deal are fulfilled;
(e) the agent is selected from the list of a travel agent, a host or a junketeer or is the punter himself directly purchasing the deal, and the commission is a discount for directly purchasing the conditional deal;
(f) the casino operator provides the punter with proof of fulfillment of the gaming obligation and punter uses said proof of fulfillment to obtain a refund from the agent, and
(g) proof of fulfillment of gaming obligation is used by agent to collect the commission.
